(19) United States
(12) Patent Application Publication
(10) Pub. No.: US 2004/0062874 A1
(43) Pub. Date: Apr. 1, 2004

(54) Nozzle assembly, system and method for wet processing a semiconductor wafer

(76) Inventors: Yong Bae Kim, Cupertino, CA (US); Kent Child, Los Banos, CA (US); Yong Ho Lee, Fremont, CA (US); In Kwon Jeong, Cupertino, CA (US); Jungyup Kim, San Jose, CA (US)

Correspondence Address: Wilson & Ham, PMB: 348, 2530 Berryessa Road, San Jose, CA, 95132, US

(21) Appl. No.: 10/219,967

(22) Filed: Aug. 14, 2002

(51) Int. Cl. B05B 1/08; B01J 19/10; B05B 3/00; B05D 1/02

(52) U.S. Cl. 427/421; 427/560; 118/300; 118/323; 239/102.1

(57) ABSTRACT

A system and method for wet cleaning a semiconductor wafer utilizes a nozzle assembly to combine two or more input fluids to form a cleaning fluid at the point-of-use. The input fluids are received at the nozzle assembly and combined in a chamber of the nozzle assembly to form the cleaning fluid. The nozzle assembly may include an acoustic transducer to generate an acoustic energy, one or more valves, e.g., three-way valves, to control the receipt of input fluids and/or a flow control mechanism, e.g., a pressure spring valve, to control dispensing of the cleaning fluid onto a surface of the semiconductor wafer.

### FIELD OF THE INVENTION

The invention relates generally to semiconductor fabrication processing, and more particularly to a nozzle assembly, system and method for wet processing a semiconductor wafer. BACKGROUND OF THE INVENTION

As the semiconductor industry strives to continuously scale down semiconductor devices, the removal of chemical contaminants, particulate impurities and/or residual photoresist material is becoming a more critical aspect of semiconductor fabrication processing. Due to the microscopic scale of features on current semiconductor devices, even small amounts of contaminants, impurities and/or residual material remaining on a semiconductor wafer after a particular process can be detrimental to the resulting semiconductor devices with respect to performance and reliability.

Traditionally, semiconductor wafers have been cleaned in batches by sequentially immersing the wafers into baths of different cleaning fluids, i.e., wet benches. However, with the advent of sub-0.18 micron geometries and 300 mm wafer processing, the use of batch cleaning has increased the potential for defective semiconductor devices due to cross-contamination and residual contamination.

Single-wafer cleaning techniques have been developed to mitigate the shortcomings of batch cleaning processes. Conventional single-wafer cleaning systems typically include a single fluid delivery line to dispense one or more cleaning fluids, such as de-ionized water, standard clean 1 (SC1) solution and standard clean 2 (SC2) solution, onto a surface of semiconductor wafer in an enclosed environment. Since some chemicals that are used in the cleaning solutions are volatile, these chemicals are mixed outside of the enclosed environment and supplied through the delivery line.

A concern with conventional single-wafer cleaning systems that utilize a single delivery line is that a significant amount of cleaning fluid will remain in the delivery line after the cleaning fluid has been delivered. Since the remaining cleaning fluid may have an adverse chemical reaction with a subsequent cleaning fluid that is introduced into the delivery line, the remaining cleaning fluid should be discarded from the delivery line prior to the delivery of the subsequent cleaning fluid. Even in a cleaning process using one cleaning fluid, the cleaning fluid that remains in the delivery line may have to be discarded to ensure the cleaning fluid being used is fresh and still has the desired chemical properties. The discarding of cleaning fluids that remain in the delivery line contributes to an increased operating expense of the single-wafer cleaning system.

Single-wafer cleaning systems with multiple delivery lines have been developed to supply different cleaning fluids through dedicated delivery lines. The use of multiple delivery lines eliminates the potential for cross-contamination of cleaning fluids in the delivery lines. However, multiple delivery lines do not resolve the issue of providing fresh cleaning fluid for proper wafer cleaning process.

Some conventional single-wafer cleaning systems include an acoustic transducer to generate acoustic energy, which is used to assist in the removal of particulates on a semiconductor wafer. The acoustic transducer is typically positioned over the semiconductor wafer during the cleaning process to apply the generated acoustic energy directly onto the wafer surface being cleaned.

A concern with conventional single-wafer cleaning systems that use an acoustic transducer is that the applied acoustic energy may damage the features formed on the semiconductor wafer. Therefore, the output of the acoustic transducer must be carefully controlled to ensure that the acoustic energy is strong enough to clean the semiconductor wafer but not too strong to damage the delicate features on the semiconductor wafer.

In view of the above-described concerns, there is a need for a system and method for cleaning a semiconductor wafer in an efficient and effective manner.

### SUMMARY OF THE INVENTION

A system and method for wet cleaning a semiconductor wafer utilizes a nozzle assembly to combine two or more input fluids to form a cleaning fluid at the point-of-use. The input fluids are received at the nozzle assembly and combined in a chamber of the nozzle assembly to form the cleaning fluid. Since the cleaning fluid is formed at the nozzle assembly, the cleaning fluid is always fresh when dispensed from the nozzle assembly and only a small amount of the cleaning fluid is left unused in the nozzle assembly. The nozzle assembly may be configured to generate an acoustic energy, which is used to assist in the mixing of the input fluids in the nozzle assembly and to assist in the cleaning of a surface of a semiconductor wafer. The system and method may be used to clean objects other than semiconductor wafers, such as liquid crystal display (LCD) substrate.

A system in accordance with the invention includes an object support structure and a nozzle assembly. The object support structure is configured to support an object to be cleaned, e.g., a semiconductor wafer. The nozzle assembly is configured to be positioned over the object support structure to dispense a processing fluid onto a surface of the object. The nozzle assembly is connected to a fluid supply through at least two inlet conduits to receive first and second fluids. The nozzle assembly is configured to combine the first and second fluids at the nozzle assembly to produce the processing fluid.

The nozzle assembly may further include an acoustic transducer, one or more three-way valves and/or a flow control mechanism. The acoustic transducer is configured to generate an acoustic energy, which may be megasonic or ultrasonic. The three-way valves, which are each connected to a particular inlet conduit and an outlet conduit, are configured to selectively route fluids to the respective outlet conduits. The flow control mechanism, e.g., a pressures spring valve, is configured to control the dispensing of the processing fluid from the nozzle assembly.

A method in accordance with the invention includes receiving first and second fluids at a nozzle assembly, combining the first and second fluids in the nozzle assembly to form a processing fluid, and dispensing the processing fluid from the nozzle assembly onto a surface of an object to process the object.

The method may further include generating an acoustic energy at the nozzle assembly, switching one or more three-way valves from a first state to a second state to allow one of the first and second fluids to be received at the nozzle assembly and/or opening a flow control mechanism, e.g., a pressure spring valve, to dispense the processing fluid. The generated acoustic energy may be megasonic or ultrasonic.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a system for cleaning a semiconductor wafer in accordance with an exemplary embodiment of the present invention.

FIG. 2 is a diagram of a nozzle assembly included in the cleaning system of FIG. 1.

FIG. 3 is a process flow diagram of the operation of the cleaning system of FIG. 1.

FIG. 4 is a process flow diagram of a method of cleaning a semiconductor wafer in accordance with an exemplary embodiment of the invention.

### DETAILED DESCRIPTION

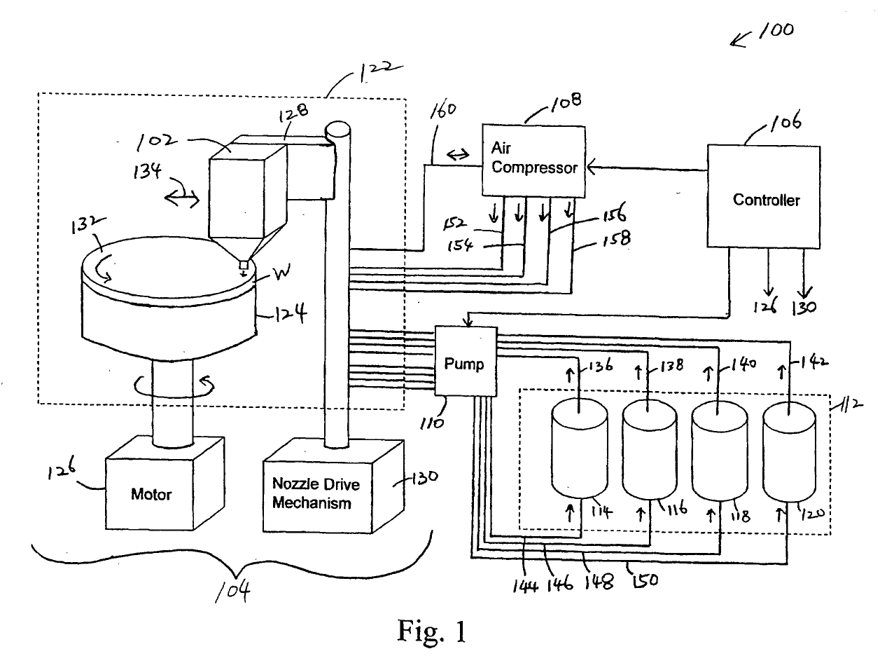

With reference to FIG. 1, a system 100 for cleaning a semiconductor wafer in accordance with an exemplary embodiment of the invention is shown. The cleaning system includes a nozzle assembly 102 to efficiently dispense different cleaning fluids onto a surface of a semiconductor wafer W. As described in more detail below, the nozzle assembly is designed to allow two or more input fluids to be mixed to produce the desired cleaning fluid at the point-of-use, i.e., the nozzle assembly, so that the cleaning fluid is always fresh when dispensed from the nozzle assembly and so that only a small amount of the cleaning fluid is left unused in the nozzle assembly. The nozzle assembly is further designed to generate acoustic energy to assist in the mixing of the input fluids in the nozzle assembly to form the desired cleaning fluid and to assist in the removal of particulates on the semiconductor wafer. In the exemplary embodiment, the acoustic energy applied to the surface of the semiconductor wafer is attenuated to ensure that the delicate features on the semiconductor wafer are not damaged during the cleaning process.

The cleaning system 100 includes a single-wafer cleaning unit 104, a controller 106, an air compressor 108, a pump 110 and a supply 112 of cleaning fluids. The cleaning fluid supply 112 includes containers 114, 116, 118 and 120 to store different types of cleaning fluids or fluids that can be combined to form cleaning fluids. Although the cleaning fluid supply is shown in FIG. 1 to include four containers, the cleaning fluid supply may include fewer or more containers. The fluids stored in the containers may include the following fluids: de-ionized water, diluted HF, mixture of NH₄OH and H₂O, standard clean 1 or “SC1” (mixture of NH₄OH, H₂O₂ and H₂O), standard clean 2 or “SC2” (mixture of HCl, H₂O₂ and H₂O), ozonated water (de-ionized water with dissolved ozone), modified SC1 (mixture of NH₄OH and H₂O with ozone), modified SC2 (mixture of HCl and H₂O with ozone), known cleaning solvents (e.g., a hydroxyl amine based solvent EKC265, available from EKC technology, Inc.), or any constituent of these fluids. The types of fluids stored in the containers of the cleaning fluid supply can vary depending on the particular cleaning process to be performed by the cleaning system.

The single-wafer cleaning unit 104 includes a processing chamber 122, which provides an enclosed environment for cleaning a single semiconductor wafer, e.g., the semiconductor wafer W. The single-wafer cleaning unit further includes a wafer support structure 124, a motor 126, the nozzle assembly 102, a mechanical arm 128 and a nozzle drive mechanism 130. The wafer support structure 124 is configured to securely hold the semiconductor wafer W for cleaning. The wafer support structure is connected to the motor 126, which provides rotational motion for the wafer support structure. Consequently, the wafer support structure is also configured to rotate the semiconductor wafer during the cleaning process. The wafer support structure can be any wafer support structure that can securely hold a semiconductor wafer and rotate the wafer, such as conventional wafer supports structures that are currently used in commercially available single-wafer wet cleaning systems.

The nozzle assembly 102 is attached to the mechanical arm 128, which is connected to the nozzle drive mechanism 130. In the exemplary embodiment, the nozzle drive mechanism 130 moves the nozzle assembly laterally across the surface 132 of the semiconductor wafer W being cleaned, as indicated by the arrow 134, by manipulating the mechanical arm. The lateral movement of the nozzle assembly allows the cleaning fluid dispensed from the nozzle assembly to be applied to the entire surface of the semiconductor wafer. However, in other embodiments, the nozzle drive mechanism may be configured to move the nozzle assembly in any number of different possible directions, including the vertical direction.

The cleaning fluid dispensed by the nozzle assembly 102 may be a solution produced by combining two or more input fluids stored in the containers 114-120 of the cleaning fluid supply 112. Alternatively, the cleaning fluid may be one of the original input fluids. The input fluids are supplied to the nozzle assembly from the cleaning fluid supply via inlet conduits 136,138, 140 and 142, which connect each container of the cleaning fluid supply to the nozzle assembly through the mechanical arm 128. Each container of the cleaning fluid supply is also connected to the nozzle assembly via outlet conduits 144, 146, 148 and 150. Thus, each container includes two conduits to the nozzle assembly, an inlet conduit and an outlet conduit. The outlet conduits serve to return input fluids that are currently not being used at the nozzle assembly back to the containers of the cleaning fluid supply. The inlet and outlet conduits are connected to the pump 110 that pumps the input fluids through the conduits. In the exemplary embodiment, the input fluids are continuously circulated between the nozzle assembly and the containers of the cleaning fluid supply through the inlet and outlet conduits. When a particular input fluid is needed to clean the semiconductor wafer, that particular input fluid is extracted from the corresponding inlet conduit at the nozzle assembly. During the extraction, the input fluid is not re-circulated back to the originating container. However, as soon as the extraction ends, the re-circulation of the input fluid is resumed. In other embodiments, the input fluids may not be re-circulated or may be re-circulated at some other location external to the nozzle assembly, e.g., at the pump 110. If the input fluids are not re-circulated, then only the inlet conduits from the containers 114-120 of the cleaning fluid supply 112 to the nozzle assembly 102 are needed. Similarly, if the input fluids are re-circulated at some location external to the nozzle assembly, then only the inlet conduits need to be connected to the nozzle assembly. That is, the outlet conduits need not be connected to the nozzle assembly.

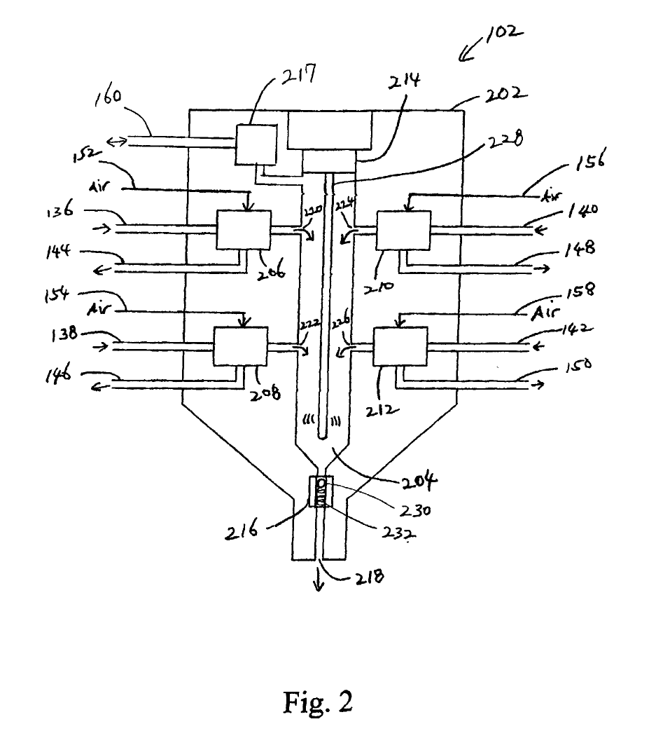

Turning now to FIG. 2, a cross-sectional diagram of the nozzle assembly 102 in accordance with the exemplary embodiment is shown. As illustrated, the nozzle assembly includes a nozzle structure 202 with a chamber 204, three-way valves 206, 208, 210 and 212, an acoustic transducer 214, a pressure spring valve 216 and an airflow control mechanism 217. The chamber is formed by the nozzle structure and is fluidally connected to an output opening 218, which is used to dispense the cleaning fluid from the nozzle assembly. The chamber is used to mix different input fluids from the cleaning fluid supply 112 to produce a desired cleaning fluid. In some instances, an unmixed input fluid may be used as a cleaning fluid. The chamber can be any sized region of any shape where input fluids can be combined. The input fluids are selectively introduced into the chamber by the three-way valves 206-212, which are connected to the chamber via openings 220, 222, 224 and 226, respectively. Each three-way valve is also connected to an inlet conduit and an outlet conduit, as illustrated in FIG. 2.

The three-way valves 206-212 of the nozzle assembly 102 operate in two states, open and re-circulate states. In the open state, each three-way valve allows the input fluid from the connected inlet conduit to flow into the chamber 204 through the corresponding opening. In the re-circulate state, each three-way valve allows the input fluid from the connected inlet conduit to flow into the connected outlet conduit so that the cleaning fluid is returned to the originating container of the cleaning fluid supply 112. In the exemplary embodiment, the three-way valves are actuated by air pressure or any other pressurized gas. Thus, the three-way valves are connected to the air compressor 108 via lines 152, 154, 156 and 158, which are illustrated in both FIGS. 1 and 2. Although the three-way valves are shown to be within the nozzle structure 202, the three-way valves may be externally attached to the nozzle structure. Alternatively, the three-way valves may be detached from the nozzle assembly and may be located inside or outside of the processing chamber 122. In some embodiments, other fluid routing mechanisms may be used instead of the three-way valves to perform the same function of the three-way valves. As an example, each three-way valve may be replaced by two standard two-way valves, which may be strategically positioned to perform the same function as the replaced three-way valve.

The acoustic transducer 214 of the nozzle assembly 102 operates to generate acoustic energy, which is imparted to the fluid in the chamber 204. The acoustic energy is used in part to assist in the mixing of input fluids in the chamber to produce a combined cleaning fluid. The acoustic energy generated by the acoustic transducer may be megasonic or ultrasonic. In the exemplary embodiment, the acoustic transducer includes an elongated member 228, which is positioned in the chamber. The elongated member ensures that the acoustic transducer is in contact with the fluid in the chamber, even if the chamber is not completely filled. The acoustic energy generated by the acoustic transducer may also be used to assist in the removal of particulates on the surface of the semiconductor wafer being cleaned. However, unlike conventional single-wafer wet cleaning systems that apply acoustic energy directly to the surface of a semiconductor wafer, the acoustic energy generated by the acoustic transducer of the nozzle assembly is attenuated by the pressure spring valve 216, which is located between the chamber and the output opening 218. The attenuation of acoustic energy by the pressure spring valve ensures that delicate features on the surface of the semiconductor wafer are not damaged by the acoustic energy during the cleaning process.

The pressure spring valve 216 of the nozzle assembly 102 operates to control the dispensing of the cleaning fluid in the chamber 204 onto the surface 132 of the semiconductor wafer W. Thus, the pressure spring valve functions as a flow control mechanism for the nozzle assembly. The pressure spring valve is pressure sensitive in that the valve is opened only when pressure greater than a predefined pressure is applied to the valve. In the exemplary embodiment, the pressure spring valve includes a ball 230 and a spring 232. When the pressure in the chamber does not exceed the predefined pressure, the pressure spring valve remains closed by the ball, which is held in place at an original position by the force of the spring, as illustrated in FIG. 2. However, when the pressure in the chamber exceeds the predefined pressure, the spring compresses, lowering the ball. Consequently, the pressure spring valve opens, ejecting the cleaning fluid in the chamber through the pressure spring valve onto the semiconductor wafer. When the pressure in the chamber again falls below the predefined pressure, the spring moves the ball back to its original position, closing the pressure spring valve. In addition to controlling the dispensing of the cleaning fluid from the nozzle assembly, the spring of the pressure spring valve assists in the mixing of input fluids in the chamber as the input fluids pass through the valve. The spring is located along a fluid pathway of the pressure spring valve. Thus, the spring creates fluid turbulence as fluids pass through the fluid pathway. The fluid turbulence created by the spring assists in the mixing of the fluids. The fluid turbulence created by the spring also serves to attenuate the acoustic energy generated by the acoustic transducer 214. The pressure spring valve may also be used to control the pressure of the ejecting cleaning fluid from the nozzle assembly. Since the predefined pressure of the pressure spring valve affects the pressure of the ejected cleaning fluid, the pressure of the ejected cleaning fluid can be controlled by adjusting the predefined pressure of the pressure spring valve. As an example, a pressure spring valve having a higher pressure setting may be used to reduce the pressure of the ejected cleaning fluid from the nozzle assembly.

The airflow control mechanism 217 of the nozzle assembly 102 operates to control flow of air into and out of the chamber 204. In the exemplary embodiment, the airflow control mechanism is connected to the air compressor 108 through a line 160 to receive pressurized air or any other pressurized gas. Alternatively, the airflow control mechanism may be connected to a different air compressor (not shown). The pressurized air is used to empty the chamber of fluids, prior to receiving fresh input fluids. When supplied with pressurized air, the airflow control mechanism is configured to allow the pressurized air to flow into the chamber, emptying the chamber of fluids by activating (i.e., opening) the pressure spring valve 216. When the pressurized air is not supplied, the airflow control mechanism is configured to allow air to vent out of the chamber so that the chamber can be filled with fresh input fluids without being ejected out of the chamber through the pressure spring valve. Thus, the line 160 functions as a vent as well as an air supply line. However, the airflow control mechanism is configured to block fluids from escaping the chamber through the airflow control mechanism. Thus, when the chamber has filled with fluids up to the airflow control mechanism, the airflow control mechanism becomes a closed gate, preventing the fluids from flowing through the mechanism. Consequently, the pressure of the input fluids coming into the chamber increases the pressure in the chamber until the chamber pressure exceeds the threshold pressure of the pressure spring valve, activating the valve and ejecting the fluids out of the chamber through the output opening 218.

In the exemplary embodiment, the airflow control mechanism 217 comprises a check valve and air vent valve. The check valve regulates the airflow through into and out of the chamber 204, while preventing fluids from flowing out of the chamber. The air vent allows the air from the chamber to escape to ambient environment, if the air is non-hazardous, or to a container (not shown) for disposal, if the air is or potentially hazardous. The air vent may be located at the nozzle assembly 102, at the air compressor 108 or at any location along the line 160. In other embodiments, the airflow control mechanism may be implemented using other devices that can be used to regulate flow of air and fluids.

Turning back to FIG. 1, the controller 106 of the cleaning system 100 operates to control various components of the system. The controller controls the motor 126, which rotates the wafer support structure 124. The controller also controls the nozzle drive mechanism 130, which moves the nozzle assembly 102 across the semiconductor wafer W on the wafer support structure 124. In addition, the controller controls the three-way valves 206-212 of the nozzle assembly by controlling the air pressure applied to the three-way valves by way of the air compressor 108. Thus, the controller can selectively introduce the input fluids from the cleaning fluid supply 112 into the chamber 204 of the nozzle assembly, so that a desired cleaning fluid, which may be a mixture of input fluids, can be applied to the surface 132 of the semiconductor wafer W. The controller further controls the emptying of the chamber of fluids by selectively supplying pressurized air into the chamber through the airflow control mechanism 217 by way of the air compressor. The controller also controls the pump 110, which pumps the input fluids through the inlet conduits 136-142 and outlet conduits 144-150. Consequently, the controller is able to control the pressure of the cleaning fluid ejected from the nozzle assembly by controlling the pressure of the input fluids through the conduits.

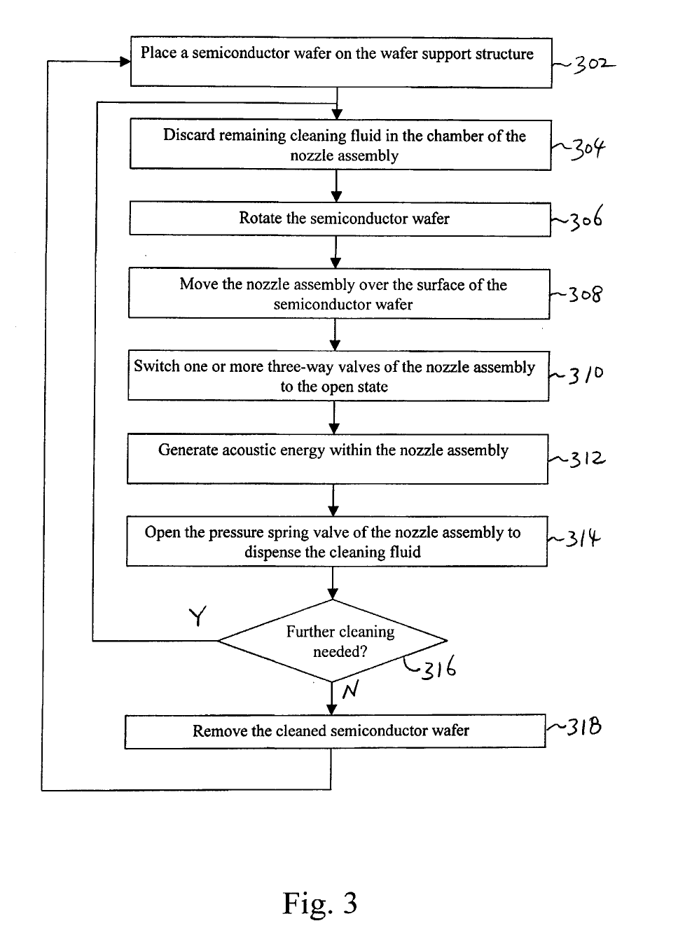

The operation of the cleaning system 100 is described with reference to FIGS. 1, 2 and 3. At step 302, a semiconductor wafer to be cleaned, e.g., the semiconductor wafer W, is placed on the wafer support structure 124 of the single-wafer cleaning unit 104. Next, at step 304, remaining cleaning fluid in the chamber 204 of the nozzle assembly 102 is discarded by ejecting the cleaning fluid away from the semiconductor wafer. Step 304 may be performed prior to step 302. In the exemplary embodiment, the remaining cleaning fluid in the chamber is discarded by supplying pressurized air into the chamber through the airflow control mechanism 217, which ejects the remaining cleaning fluid through the pressure spring valve 218. Next, at step 306, the wafer support structure 124 is rotated by the motor 126, which rotates the semiconductor wafer on the wafer support structure. At step 308, the nozzle assembly is moved over the surface of the semiconductor wafer by the nozzle drive mechanism 130. Next, at step 310, one or more of the three-way valves 206-212 of the nozzle assembly are switched to the open state, allowing the input fluids to flow through the switched three-way valves into the chamber 204 of the nozzle assembly. In the exemplary embodiment, the flow of the input fluids into the chamber forces the air in the chamber to escape through the airflow control mechanism. At step 312, an acoustic energy is generated within the nozzle assembly by the acoustic transducer 214, imparting the acoustic energy to the input fluids in the chamber. In the exemplary embodiment, the generated acoustic energy is strong enough to assist in the mixing of the input fluids in the chamber and to assist in the removal of particulates on the surface of the semiconductor wafer.

Next, at step 314, the pressure spring valve 216 of the nozzle assembly 102 is opened to dispense the cleaning fluid from the chamber 204 onto the surface of the semiconductor wafer. The cleaning fluid may be a mixture of input fluids or an individual input fluid. In the exemplary embodiment, the cleaning fluid is ejected as the nozzle assembly is moved across the surface of the semiconductor wafer to apply the cleaning fluid over the entire wafer surface. At step 316, a determination is made as to whether further cleaning is needed. This determination is dependent on the particular cleaning process being performed. If further cleaning is needed, the process proceeds back to step 304, and steps 304-316 are repeated. However, if further cleaning is not needed, then the process proceeds to step 318, at which the cleaned semiconductor wafer is removed from the single-wafer cleaning unit 104. Next, the process proceeds back to step 302, at which another semiconductor wafer to be cleaned is placed on the wafer support structure and the entire process is repeated.

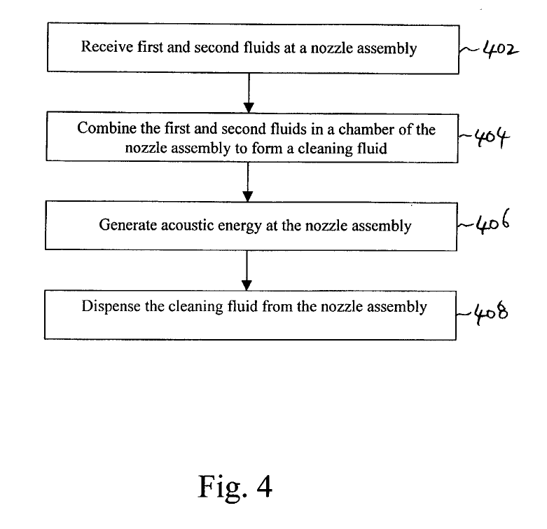

A method of cleaning a semiconductor device in accordance with an exemplary embodiment of the invention is described with reference to the process flow diagram of FIG. 4. At step 402, first and second fluids are received at a nozzle assembly. The first and second fluids may be any type of fluids, mixtures of fluids or solvents that can be used to clean semiconductor wafers. Next, at step 404, the first and second fluids are combined in a chamber of the nozzle assembly to form a cleaning fluid. At step 406, an acoustic energy is generated at the nozzle assembly. The acoustic energy may be megasonic or ultrasonic. Steps 404 and 406 may be performed concurrently. Next, at step 408, the cleaning fluid is dispensed from the nozzle assembly onto a surface of a semiconductor wafer.

Although specific embodiments of the invention have been described and illustrated, the invention is not to be limited to the specific forms or arrangements of parts so described and illustrated. As an example, the invention may be used to clean objects other than semiconductor wafers, such as LCD substrate. The scope of the invention is to be defined by the claims appended hereto and their equivalents.

What is claimed is:

1. A system for processing an object comprising:
an object support structure that is configured to support said object; and
a nozzle assembly configured to be positioned over said object support structure to dispense a processing fluid onto a surface of said object, said nozzle assembly being connected to a fluid supply through at least two inlet conduits to receive first and second fluids from said fluid supply, said nozzle assembly being configured to combine said first and second fluids at said nozzle assembly to produce said processing fluid.

2. The system of claim 1 wherein said nozzle assembly includes an acoustic transducer configured to generate an acoustic energy.

3. The system of claim 2 wherein said acoustic energy generated by said acoustic transducer is either megasonic or ultrasonic.

4. The system of claim 1 further comprising at least one three-way valve connected to a particular inlet conduit of said inlet conduits, said three-way valve being connected to an outlet conduit that leads away from said nozzle assembly, said three-way valve being configured to selectively route one of said first and second fluids to said outlet conduit.

5. The system of claim 4 wherein said nozzle assembly includes said three-way valve.

6. The system of claim 4 wherein said outlet conduit leads back to said fluid supply.

7. The system of claim 1 wherein said nozzle assembly includes a chamber to receive said first and second fluids from said inlet conduits, said nozzle assembly further including a flow control mechanism in fluidal connection with said chamber, said flow control mechanism being configured to control dispensing of said processing fluid from said nozzle assembly.

8. The system of claim 7 wherein said flow control mechanism includes a pressure sensitive valve that is configured to open when a predefined pressure is applied.

9. The system of claim 8 wherein said pressure sensitive valve is a pressure spring valve.

10. The system of claim 7 wherein said nozzle assembly further includes an acoustic transducer configured to generate an acoustic energy, said acoustic transducer including an elongated portion that is positioned within said chamber.

11. The system of claim 7 wherein said nozzle assembly includes an airflow control mechanism fluidally connected to said chamber, said airflow control mechanism being configured to allow gases to be transmitted bidirectionally through said airflow control mechanism, said airflow control mechanism being further configured to prevent said first and second fluids from flowing out of said chamber.

12. The system of claim 11 wherein said airflow control mechanism includes a check valve.

13. A nozzle assembly for dispensing an object processing fluid comprising:
a nozzle structure having a chamber and an output opening, said chamber including at least two inlet openings to receive first and second fluids to combine said first and second fluids in said chamber to produce said object processing fluid, said chamber being in fluidal connection with said output opening to dispense said object processing fluid; and
a flow control mechanism positioned between said chamber and said output opening to control dispensing of said object processing fluid from said chamber of said nozzle structure.

14. The nozzle assembly of claim 13 further comprising an acoustic transducer operatively connected to said nozzle structure, said acoustic transducer being configured to generate an acoustic energy.

15. The nozzle assembly of claim 14 wherein said acoustic energy generated by said acoustic transducer is either megasonic or ultrasonic.

16. The nozzle assembly of claim 14 wherein said acoustic transducer includes an elongated portion that is positioned within said chamber of said nozzle structure.

17. The nozzle assembly of claim 13 further comprising at least one three-way valve attached to said nozzle structure, said three-way valve being connected to a particular inlet opening of said inlet openings, said three-way valve being further connected to an inlet conduit and an outlet conduit, said three-way valve being configured to selectively route one of said first and second fluids from said inlet conduit to said particular inlet opening or to said outlet conduit.

18. The nozzle assembly of claim 17 wherein said inlet conduit and said outlet conduit are both connected to a common fluid supply.

19. The nozzle assembly of claim 13 wherein said flow control mechanism includes a pressure sensitive valve that is configured to open when a predefined pressure is applied.

20. The nozzle assembly of claim 19 wherein said pressure sensitive valve is a pressure spring valve.

21. The nozzle assembly of claim 13 further comprising an airflow control mechanism fluidally connected to said chamber, said airflow control mechanism being configured to allow gases to be transmitted bidirectionally through said airflow control mechanism, said airflow control mechanism being further configured to prevent said first and second fluids from flowing out of said chamber.

22. The nozzle assembly of claim 21 wherein said airflow control mechanism includes a check valve.

23. A nozzle assembly for dispensing an object processing fluid comprising:
a nozzle structure having an opening to dispense said object processing fluid, said opening being in fluidal connection with at least two inlet conduits to individually receive first and second fluids so that said first and second fluids are combined at said nozzle structure to produce said object processing fluid; and
an acoustic transducer operatively connected to said nozzle structure to generate acoustic energy that is imparted to said first and second fluids.

24. The nozzle assembly of claim 23 wherein said acoustic energy generated by said acoustic transducer is either megasonic or ultrasonic.

25. The nozzle assembly of claim 23 further comprising at least one three-way valve attached to said nozzle structure, said three-way valve being located on a particular inlet conduit of said inlet conduits, said three-way valve being connected to an outlet conduit that leads away from said nozzle structure, said three-way valve being configured to selectively route one of said first and second fluids to said outlet conduit.

26. The nozzle assembly of claim 25 wherein said particular inlet conduit and said outlet conduit are both connected to a common fluid supply.

27. The nozzle assembly of claim 23 further comprising a flow control mechanism near said opening of said nozzle structure, said flow control mechanism being configured to control dispensing of said object processing fluid from said nozzle structure.

28. The nozzle assembly of claim 27 wherein said flow control mechanism includes a pressure sensitive valve that is configured to open when a predefined pressure is applied.

29. The nozzle assembly of claim 28 wherein said pressure sensitive valve includes a pressure spring valve.

30. The nozzle assembly of claim 23 wherein said nozzle structure includes a chamber fluidally connected to said inlet conduits and said opening, said chamber providing a region where said first and second fluids can combine to form said object processing fluid.

31. The nozzle assembly of claim 30 further comprising an airflow control mechanism fluidally connected to said chamber, said airflow control mechanism being configured to allow gases to be transmitted bidirectionally through said airflow control mechanism, said airflow control mechanism being further configured to prevent said first and second fluids from flowing out of said chamber.

32. The nozzle assembly of claim 31 wherein said airflow control mechanism includes a check valve.

33. The nozzle assembly of claim 30 wherein said acoustic transducer includes an elongated portion that is positioned within said chamber of said nozzle structure.

34. A method of processing an object comprising:
receiving first and second fluids at a nozzle assembly;
combining said first and second fluids in said nozzle assembly to form a processing fluid;
dispensing said processing fluid from said nozzle assembly onto a surface of said object to process said object.

35. The method of claim 34 further comprising generating an acoustic energy at said nozzle assembly, including imparting said acoustic energy to said first and second fluids in said nozzle assembly.

36. The method of claim 35 wherein said generating of said acoustic energy includes generating a megasonic or ultrasonic energy.

37. The method of claim 35 wherein said generating of said acoustic energy includes generating said acoustic energy using an acoustic transducer having an elongated portion, said elongated portion being positioned in a chamber of said nozzle assembly where said first and second fluids are received.

38. The method of claim 34 wherein said receiving of said first and second fluids at said nozzle assembly includes receiving said first and second fluids at a chamber of said nozzle assembly.

39. The method of claim 38 further comprising supplying gas into said chamber of said nozzle assembly to remove said chamber of remaining fluids.

40. The method of claim 38 wherein said receiving of said first and second fluids at said chamber of said nozzle assembly includes allowing gas in said chamber to escape said chamber and preventing said first and second fluids from escaping said chamber.

41. The method of claim 38 further comprising switching at least one three-way valve from a first state to a second state to allow one of said first and second fluids to be received at said chamber of said nozzle assembly, said three-way valve being configured to route one of said first and second fluids away from said nozzle assembly when in said first state.

42. The method of claim 34 wherein said dispensing of said processing fluid includes opening a flow control mechanism near an output opening of said nozzle assembly.

43. The method of claim 42 wherein said flow control mechanism includes a pressure spring valve that is configured to open when a predefined pressure is applied.

44. The method of claim 34 wherein said dispensing of said processing fluid includes passing said processing fluid through a fluid pathway that is configured create fluid turbulence to assist in mixing of said first and second fluids of said processing fluid.
